(19) United States
(12) Patent Application Publication
(10) Pub. No.: US 2021/0217300 A1
(43) Pub. Date: Jul. 15, 2021

(54) COPPER AND/OR FIBER OPTIC BASED ETHERNET CABLE ADDED WITH INTEGRATED IR INFRARED REMOTE CONTROL WITHOUT REDUCING ETHERNET CONNECTIONS & STANDARD SPECS

(71) Applicants: Luca ZANETTI, Orlando, FL (US); Silvia FlORAVANTI, Orlando, FL (US)

(72) Inventors: Luca ZANETTI, Orlando, FL (US); Silvia FlORAVANTI, Orlando, FL (US)

(21) Appl. No.: 16/743,518

(22) Filed: Jan. 15, 2020

(51) Int. Cl. G08C 23/04; G08C 23/06; G02B 6/44; H01B 1/02; H01B 11/22

(52) U.S. Cl. CPC G08C 23/04; G08C 23/06; H01B 11/22; H01B 1/02; G02B 6/4471

(57) ABSTRACT

A copper and/or fiber optic based ethernet cable with optical or rj45 male or female connectors, also added with integrated infrared remote control capabilities to remote control uni-directional and bi-directional audio video and ir devices remotely from each-other sides of the ethernet cable, integrated within same the ethernet cable, without requiring additional cables and devices, without disrupting or reducing the ethernet standard & connections full specs. Infrared transmitter and receiver eyes from the ethernet copper and/or fiber optic based cable can be either or both integrated in the/on to the ethernet connectors housing shell, keystone, wallplate, multimedia strip, and any other fixed or flying shape of housing, or externally connected via additional ir eyes connectors added on the ethernet connector housing shell, or extrapolated from the ethernet copper and/or fiber optic based cable using any flying wiring and any connection solution or direct without connectors.

### BACKGROUND

This invention relates to adding the infrared remote control mechanism to the Ethernet copper and/or fiber-based cables technology and production also called in some cases AOC active optical cables, to be able to remote control in an integrated within-the-same-cable way any Ethernet, av audio video, automation, and any ir remote controllable devices from each-other sides of the cable, without reducing the Ethernet full standard specs connections and functionalities.

### SUMMARY OF THE INVENTION

The present invention is directed to integrating an infrared remote control mechanism within the same ethernet copper and/or fiber-based cables technology also in some cases called ethernet aoc active optical cable, in order to facilitate the remote control of ir devices such as tvs, media players, set top boxes, disk players, av receivers, bluetooth devices, home automation devices and systems, and any other ir remote controllable device, from each-other sides of cable within the same cable, without requiring additional external cables or devices and installation, without reducing the ethernet full standard connections and functionalities specs.

### BRIEF DESCRIPTION OF THE DRAWINGS

FIG. 1 schematically illustrates the operation of the infrared mechanism added to the copper and/or AOC ethernet fiber optic based cables.

FIG. 2 schematically illustrates an example of IR eyes connection connectors installed on the ethernet copper and/or fiber-based cable housing shell.

FIG. 3 schematically illustrates an example of IR eyes connection connectors flying/floating from the ethernet copper and/or fiber-based cable housing shell.

FIG. 4 schematically illustrates an example of IR eyes connection connectors flying/floating from the ethernet copper and/or fiber-based cable.

FIG. 5 schematically illustrates an example of IR eyes connection connectors flying/floating from the ethernet copper and/or fiber-based cable with rj45 male connectors.

### DETAILED DESCRIPTION

An object of the present invention is to simplify the audio, video, multimedia, automation and any ethernet device installation by integrating the IR remote control mechanism within the same ethernet copper and/or Fiber-based cable eliminating the need of additional external converters with their eventual power supply and additional wires and reducing the system installation time and electrical power consumption, increasing the overall reliability and the environmental health.

Another object of the present invention is to be able to use the benefits of the ethernet fiber-based aoc cables technology which offers zero-loss full speed bandwidth, and add to it the ability to control ir infrared remote devices such as set top boxes, av receivers, media centers, media players, matrixes, switchers, ip players, home automation, and any ir controllable device, typically wanted/installed in another room, closet, basement, in order to keep the installation simple and clean with only the ethernet device or television set in the rooms, and all the other ir remote controllable components away, without disrupting nor reducing the full ethernet standard connection & specs features, ir remote control otherwise impossible to do with the regular ethernet copper and/or fiber-based cables so usually only achievable by adding more external components to the ethernet cable and/or additional/special shared or dedicated cables and extenders of any type.

To achieve these goals an IR infrared electric block is added and integrated to each of ethernet copper and/or fiber-based cable sides.

The infrared blocks can receive and transmit each-other the ir infrared commands captured and emitted in the rooms via ir eyes transmitters and receivers sensors connected to the infrared blocks or directly to the cable.

The ir eyes can receive or transmit or receive and transmit ir commands from ir remote controls such as tv remote controls, home automation controls, control tablets and phones, programmable ir remote controls and any ir controller—to audio video tv systems and any ir controllable devices.

The ir eyes can be integrated directly on the ethernet copper and/or fiber-based cable connectors housing shells and/or ir infrared blocks housing shells of the fiber-based ethernet cable.

The ir eyes can also be separated parts with a wire connected to the main ethernet copper and/or fiber-based cable via pluggable connectors such as 3.5 mm jacks or any other, where these pluggable IR ports can be installed and integrated directly inside the ethernet coper and/or fiber-based cable connector housing shell, or flying floating connectors from the cable.

The ir eyes might also be already connected/wired to each side of the main ethernet copper and/or fiber-based cable.

The typical installation of the ir-eye receiver is via adhesive in front of the viewing tv, so the ir eye can “see and capture” ir commands coming from the room remote control/s and send them to the other side of the ethernet copper and/or fiber-optic-based aoc cable reproducing them through the ir-eye transmitter/s in front of the remote controllable destination device/s, controlling it.

Some TV sets also provide a plug-in jack on the rear TV connections, to use the TV ir eye built-in into the TV in place of installing another adhesive ir eye in front of the TV, usually on the TV bezel. in this case the TV ir eye jack can be connected directly to the ir infrared block so the ir commands will be captured and delivered to the other side of the ethernet copper and/or fiber-based cable directly from the ir eye built-into the TV.

The copper and/or fiber optic ir infrared with ethernet cable, connectors and mechanism here described can also be added with additional data connections and connectors such as usb, serial, audio, video, data, toslink, spdif, sdi, aes ebu, hdmi, cv, component, and any other audio video data connection, to create a ir infrared cable and mechanism with multiple multi-standard connections and combination, so the ir infrared mechanism will be able no only to remote control remote ethernet devices from each-other sides of the ir ethernet copper and/or optical cable, but as well other different non ethernet devices.

The copper and/or fiber optic ir infrared with ethernet cable, connectors and mechanism here described can also be added with additional data connections and connectors such as usb (any), serial (any), audio, video (any), data (any), toslink, spdif, sdi video (any), multiple sdi video up to 8k and higher, aes ebu, hdmi, composite video, component video, and any other audio video data connection, to create a ir infrared cable and mechanism with multiple multi-standard connections and combination, so the ir infrared mechanism will be able no only to remote control remote. ethernet devices from each-other sides of the ir ethernet copper and/or optical cable, but as well other different non ethernet devices, while the ir integrated multi-standard cable will offer multiple types of connection at once with the ir control feature.

By replacing the ir sensors with different source and destination devices, the invention allows the connection between any serial data communication devices within the same ethernet cable, without disrupting, using or reducing the ethernet connection full standard and functionality (any type), without requiring additional external adapters converters, repeaters or external additional cables.

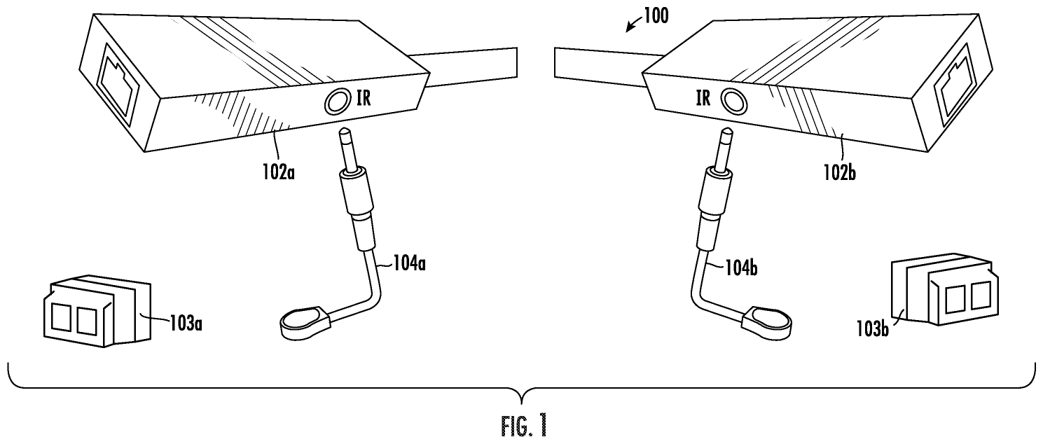

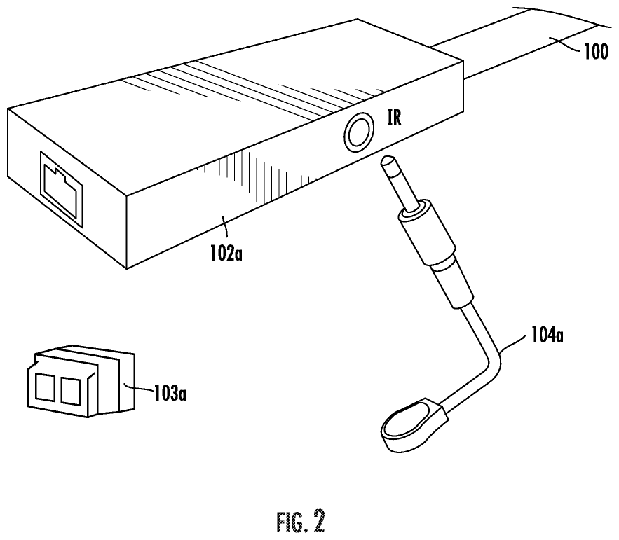

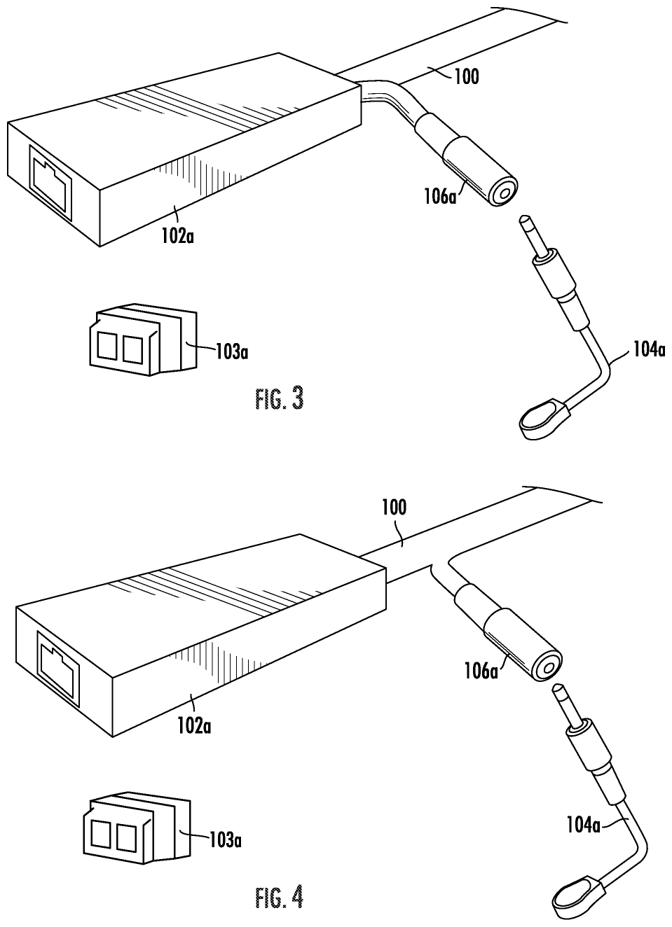

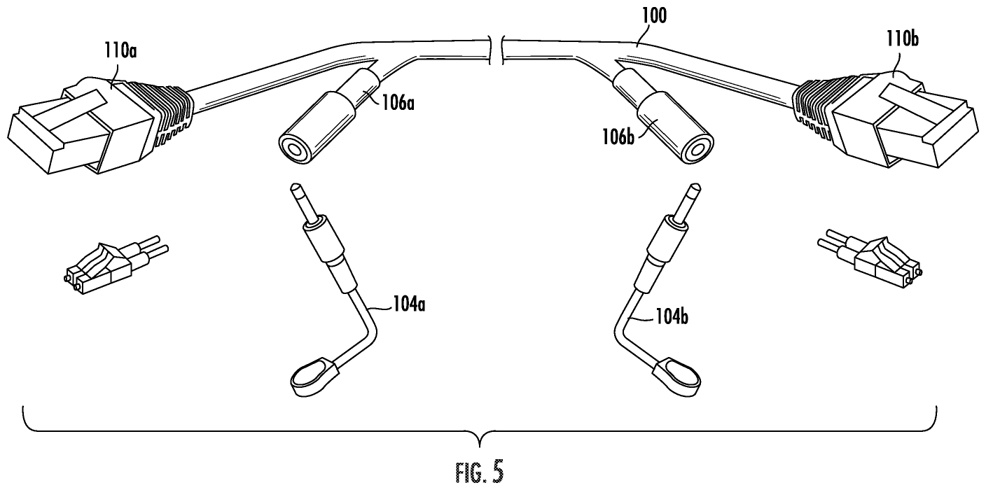

Referring now to FIGS. 1-5, a cable 100 having Ethernet with IR is illustrated. The cable 100 may comprise Ethernet copper and/or fiber based cable with integrated IR remote control extender without limiting ethernet connections and standard specifications. The Ethernet connector 102a, 102b may be any type, includingRJ45 fiber, etc., for example. IR eyes 104a, 104b may be on the ethernet connectors of flying directly out of the cable or the connectors. For bi-directional IR command operation, two IR eyes or one TX/RX eye are required with proper multi-pin connectors. IR circuits may be integrated in the ethernet connector shell or in the IR eyes or in a cable block, for example.

1. (canceled)

2. (canceled)

3. (canceled)

4. An ethernet cable comprising:
a first end having an infrared receiver configured for receiving a first set of infrared commands intended for a first device;
a second end opposite the first end and having an infrared transmitter configured to reproduce the first set of infrared commands to control a second device;
a first ethernet connector coupled to the first end of the digital cable;
a second ethernet connector coupled to the second end of the digital cable, wherein the ethernet cable is configured to transmit data signals between the first and the second ethernet connectors; and
a plurality of copper wires coupled to the infrared receiver at the first end and extending to the infrared transmitter at the second end, and the plurality of copper wires configured to communicate the first set of infrared commands from the infrared receiver to the infrared transmitter at the second end;
wherein at least two of the plurality of copper wires provides for integrated infrared serial remote communications capabilities to control devices remotely from an opposing end of the cable.

5. The ethernet cable of claim 4, further comprising a plurality of fiber optics extending from the first end to the second end.

6. The ethernet cable of claim 4, further comprising a first RJ45 fiber connector coupled to the first end, and a second RJ45 fiber connector coupled to the second end.

7. The ethernet cable of claim 4, further comprising a first IR electric block coupled to the first end and a second IR electric block coupled to the second end.

8. The ethernet cable of claim 4, wherein the infrared receiver comprises an infrared eye.

9. The ethernet cable of claim 4, wherein the second end further comprises an infrared receiver configured to receive a second set infrared commands intended for the second device.

10. The ethernet cable of claim 9, wherein the first end further comprises an infrared transmitter configured to reproduce the second set of infrared commands to control the first device.

11. The ethernet cable of claim 10, wherein the cable is configured to communicate the second set of infrared commands from the second end to the first end.

12. An ethernet cable, the cable comprising:
a first end having a first infrared receiver and transmitter, wherein the first infrared receiver and transmitter is configured for receiving and reproducing infrared commands;
a second end opposite the first end and having a second infrared receiver and transmitter, wherein the second infrared receiver and transmitter is configured for receiving and reproducing infrared commands; and
a plurality of copper wires coupled between the first infrared receiver and transmitter and the second infrared receiver and transmitter, wherein the plurality of copper wires are configured to communicate infrared commands from a respective infrared receiver to a respective infrared transmitter at an opposing end;
wherein the ethernet cable is configured to transmit data signals between the first and the second ends of the digital audio cable.

13. The ethernet cable of claim 12, further comprising a plurality of fiber optics extending from the first end to the second end.

14. The ethernet cable of claim 12, further comprising a first RJ45 fiber connector coupled to the first end, and a second RJ45 fiber connector coupled to the second end.

15. The ethernet cable of claim 13, wherein at least two of the plurality of copper wires provides for integrated infrared serial remote communications capabilities to control devices remotely from an opposing end of the ethernet cable.

16. The ethernet cable of claim 12, further comprising a first IR electric block coupled to the first end and a second IR electric block coupled to the second end.

17. The ethernet cable of claim 14, wherein the infrared receiver comprises an infrared eye.

18. The ethernet cable of claim 12, further comprising coupling the first infrared transmitter directly into the second device.

19. The ethernet cable of claim 12, further comprising an infrared eye coupled to each of the first infrared receiver and transmitter and the second infrared receiver and transmitter.

20. An ethernet cable, the ethernet cable comprising:
a first end having a first infrared eye configured for receiving and reproducing infrared commands;
a second end opposite the first end and having a second infrared eye configured for receiving and reproducing infrared commands; and
a plurality of electric wires coupled between the first infrared eye and the second infrared eye, wherein the plurality of electric wires are configured to communicate infrared commands in either direction between the first infrared eye and the second infrared eye.

21. The ethernet cable of claim 20, further comprising a plurality of fiber optics extending from the first end to the second end and configured to transmit audio signals.

22. The ethernet cable of claim 20, further comprising a first IR electric block coupled to the first end and a second IR electric block coupled to the second end.

23. The ethernet cable of claim 20, further comprising an outer covering to provide for a unitary cable from the first end to the second end.
